(19) United States
(12) Patent Application Publication
(10) Pub. No.: US 2017/0041743 A1
(43) Pub. Date: Feb. 9, 2017

(54) Methods and Systems for Reporting and Providing Improved, Close-Proximity Assistance

(71) Applicant: Punch Technologies, Inc., Charlotte, NC (US)

(72) Inventors: Gregory Brian Artzt, Weddington, NC (US); Carole Tobias, Lewisville, NC (US); Charles Andrew Prisk, Clemmons, NC (US)

(21) Appl. No.: 15/222,778

(22) Filed: Jul. 28, 2016

Related U.S. Application Data
(60) Provisional application No. 62/200,480, filed on Aug. 3, 2015.

(51) Int. Cl. H04W 4/02; H04W 4/00; H04W 4/22; H04L 29/08; H04L 12/24

(52) U.S. Cl. CPC H04W 4/021; H04L 67/22; H04L 67/18; H04L 41/06; H04W 4/22; H04W 4/028; H04W 4/008

(57) ABSTRACT

Systems and methods of monitoring users and providing a communication network such that users are able to provide assistance to each other. In the event that a user is in need of assistance, the user alerts the system indicating the type of assistance that is necessary. Upon receiving the alert, the system determines the number of other users that are in a position to help. The system signals these other users informing them of the requesting user and their type of necessary assistance. Upon receiving offers from one or more of the candidate users, the system determines the one or more most applicable users that are able to provide the assistance (referred to as the assisting users). The assisting users are given the location and need of the requesting user. The system continues to monitor the requesting user to ensure that they have been provided with the necessary assistance.

### RELATED APPLICATIONS

The present application claims the benefit of U.S. Provisional Application No. 62/200,480 filed on Aug. 3, 2015, and which is hereby incorporated by reference in its entirety.

### BACKGROUND

Despite advancements in mobile and social technologies, many people find it difficult or impossible to find help when they need it most. Though the 911 system was put into operation to address this serious problem, some people in need are incapable of calling 911 for a variety of well-known reasons. And, when a call is made to 911, response times average approximately ten minutes in the United States. Such response times are unacceptable and costs lives, damage to property and self, and so forth.

In one extreme example—Sandy Hook Elementary School—it took fifteen minutes from the first gunshot to the time officers entered the school. It was only when officers finally penetrated the school that the shooter turned the gun on himself, ending his reign of terror. It should be understood that Sandy Hook is discussed herein by way of example, and that there are thousands of other crimes and potential crimes, not mentioned here that are just as relevant to the present discussion. Some examples include, but are not limited to, university campus crime, sexual assaults, home invasion, theft, medical emergencies, and so forth.

### SUMMARY

Sometimes, we just need help from the people around us. By leveraging a community of like-minded individuals, it becomes possible to realize a response measured in seconds. The present application includes methods and systems for reporting and providing improved, close-proximity, assistance.

Briefly, a user downloads an application on their user device and signs into the application. A user can alert other users who are in close proximity that they need help. Similarly, users can be alerted by another nearby user is in distress. This function of alerting nearby users can be done on its own or simultaneously to also alerting any selected family, friends, organizations, and official responders connected and available in the network.

Upon receiving an alert request, a user makes the decision whether or not they are able to help. Help can be offered using a variety of actions including, but not limited to, capturing evidence by taking a picture or video to calling 911, capturing audio, and capturing location information via GPS or otherwise.

Additionally, a user that has received an alert from another nearby user may want to report their own tip or emergency (or “re-report”) in order to spread the word of an emergency. In the case of a disaster affecting potentially a large number of people in the vicinity, this function would allow one user to initiate a chain reaction that would make everyone in that area safer, connected, and more coordinated in their response.

In an example, often, people simply walking nearby, knocking on a door, or making a loud noise can deter or stop a personal crime such as a rape or other abuse. In some embodiments, the system is a mobile variation on community watch. There is safety in numbers and the system can play an essential role in making sure that every individual is safe in a world where they are never alone.

One embodiment is directed to a method of monitoring users that includes receiving a request over a wireless communication network for assistance from a requesting user. Based on the request, the method includes determining a number of active users necessary to provide the assistance to the requesting user. The method includes determining a size of a geographic area that extends around the requesting user based on one or more factors regarding the requesting user and the assistance requested by the requesting user. The method includes sending an alert to the active users within the geographic area with the alert comprising the assistance requested by the requesting user. The method includes receiving responses from the active users indicating a desire to respond to the requesting user. For each of the responses, determining that the active user is qualified to respond and notifying each of the active users that is qualified to respond to provide the assistance to the requesting user, the confirmation comprising at least a geographic location of the requesting user.

The method may also include that determining which of the one or more active users are applicable to respond to the requesting user includes calculating a distance from each of the active users to the geographic location of the requesting user.

The method may also include that determining which of the one or more active users are applicable to respond to the requesting user includes determining whether qualifications of the active user that are stored at a server are applicable to the assistance requested by the requesting user.

The method may also include that determining which of the one or more active users are applicable to respond to the requesting user may include determining a history of the active user in responding to previous assistance requests.

The method may include centering the geographic area around the geographic location of the requesting user.

The method may include determining that additional active users are needed by the requesting user, expanding the geographic area that extends around the user to an enlarged area based on the number of additional active users that are needed, and sending the alert to the active users within the enlarged area with the alert comprising the assistance requested by the requesting user.

Another embodiment is directed to a method of monitoring users that includes receiving a request over a wireless communication network for assistance from a requesting user. The method includes based on the request determining a total number of active users necessary to provide the assistance to the requesting user. The method includes sending a first alert to the active users that are located within a first radius of geographic proximity to the requesting user with the alert comprising the assistance requested by the requesting user. The method includes determining that a first group of the active users that responded to the first alert and who are qualified to respond. The method includes determining that the first group is less than the total number of active users necessary to provide the assistance to the requesting user. The method includes sending a second alert to the active users that are located within a larger second radius of the requesting user with the second alert comprising the assistance requested by the requesting user. The method includes determining that a second group of the active users that responded to the second alert are qualified to respond. The method includes determining that a sum of the first and second groups is equal to or greater than the total number of active users necessary to provide the assistance to the requesting user, and sending an order to each of the active users of the first and second groups to provide the assistance to the requesting user.

The method may include including a geographic location of the requesting user in the order.

Another embodiment is directed to a method of monitoring users. The method includes: receiving a request over a wireless communication network for assistance from a requesting user with the request comprising a specific need of the requesting user; based on the need of the user, determining a required number of active users necessary to provide the assistance to the requesting user; based on an expected acceptance rate from previous assistance requests, determining an expected number of the active users that must be notified to get the required number of active users; sending an alert to the expected number of active users that are each within a predetermined radius of a current location of the requesting user with the alert comprising the assistance requested by the requesting user but not including the current location of the requesting user; receiving acceptances from a group of the active users indicating that they are able to respond to the requesting user; determining which of the active users in the first group are qualified to provide the assistance to the requesting user and determining which of the active users are not qualified to provide the assistance to the requesting user; and sending an order to the qualified active users to provide the assistance to the requesting user and including the current location of the requesting user.

The method may include that determining which of the active users in the first group are qualified to provide the assistance to the requesting user may include determining the active users that are geographically closest to the current location of the requesting user.

The method may include resending the alert to a larger group of the active users that are located geographically farther away from the current location of the requesting user in response to failing to receive a predetermined number of acceptances after initially sending the alert to the expected number of the active users.

The various aspects of the various embodiments may be used alone or in any combination, as is desired.

### BRIEF DESCRIPTION OF THE DRAWINGS

FIG. 1 is a schematic diagram of a communication network.

FIG. 2 is a schematic diagram of a user device.

FIG. 3 is a schematic diagram of a server.

FIG. 4 is a sign-in screen requesting a user's email address displayed on the screen of a user device.

FIG. 5 shows the screen of a user device displaying phone, name entry, and validation information.

FIG. 6 is a signaling diagram of communications amongst a requesting user, an assisting user, and a server.

FIG. 7 is a signaling diagram of communications amongst a requesting user, an assisting user, and a server.

FIG. 8 is a flowchart diagram of a process performed by a server of determining assisting users.

FIG. 9 shows a map location screen displayed on a user device.

FIG. 10 shows one method to change the location where help is needed by entering into the user's device.

FIG. 11 shows a help request details page displayed on a user device.

FIG. 12 shows display information about a request on a user device of the person who made the help request.

FIG. 13 is a display on an active user within close proximity to the request of a requesting user.

FIG. 14 shows a screenshot resolving the incident.

FIG. 15 shows one method of self-reporting a user's experience, as displayed on the screen of the user's device.

### DETAILED DESCRIPTION

The present application is directed to systems and methods of monitoring users and providing a communication network such that users are able to call for assistance and to provide assistance to each other. In the event that a user is in need of assistance, the user alerts the system indicating the type of assistance that is necessary. Upon receiving the alert, the system determines the number of other users that are in a position to help. The system signals these other candidate users informing them of the type of necessary assistance needed by the requesting user. Upon receiving offers from one or more of the candidate users, the system determines the one or more most applicable candidate users that are able to provide the assistance (referred to as the assisting users). The assisting users are given the location and need of the requesting user. The system continues to monitor the requesting user to ensure that they have been provided with the necessary assistance.

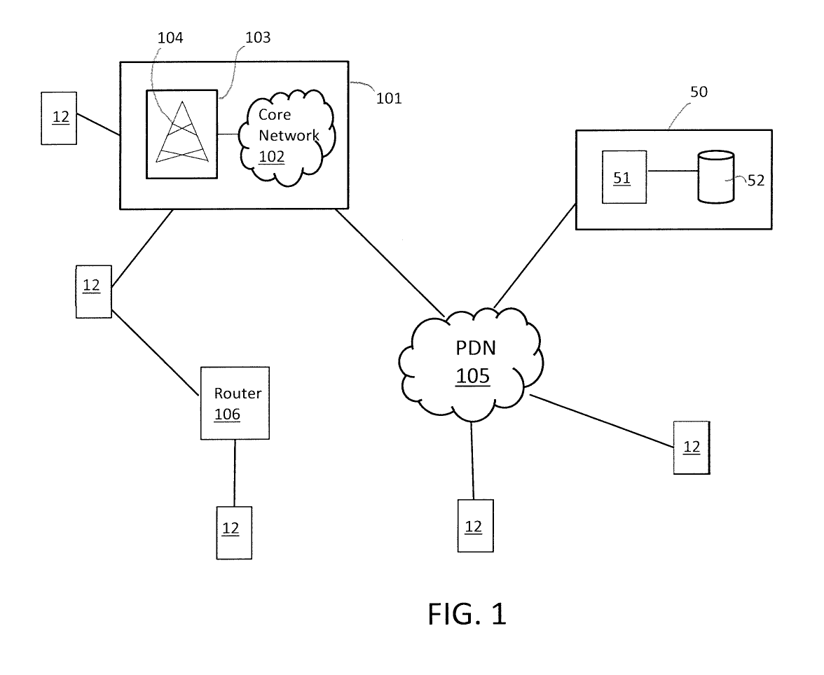

FIG. 1 illustrates an overview of the system 100 that provides for monitoring of users and providing assistance to the users. The system 100 includes a monitoring server 50 that coordinates the user monitoring and communications to provide the necessary assistance. Each user is equipped with a user device 12 that determines their geographic locations and signals the information to the server 50 over a communication network.

Each user is equipped with a user device 12. The devices may include personal digital assistants, mobile computing/communication, tablet devices, laptop computers, personal computers, and various other-like computing devices. This may also include in-board vehicle devices that are installed within their vehicles. This also includes body-worn devices 12 such as a watch or pendant configured to communicate over the network. Each of the users uses a respective device 12 and accesses the monitoring server 50 through the PDN 105, or alternatively some other network.

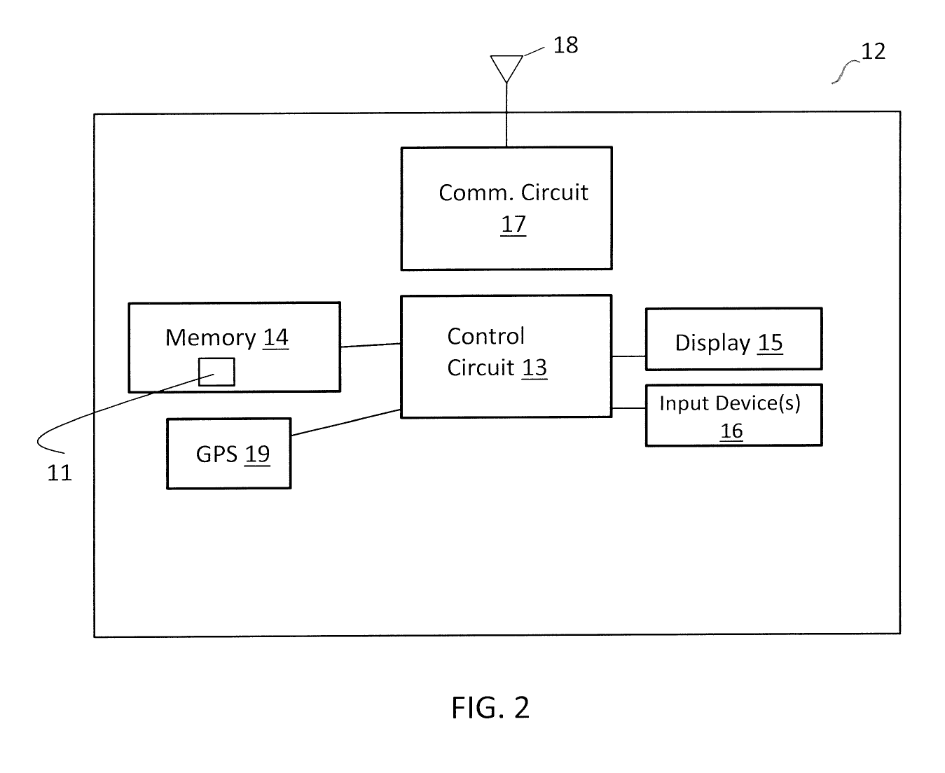

A block diagram illustrating the functional elements of a user device 12 is illustrated in FIG. 2. The device 12 includes a control circuit 13 operative to control the overall functionality of the device 12. The control circuit 13 may include one or more microprocessors, microcontrollers, Application Specific Integrated Circuits (ASICs), or other programmable devices. The control circuit 13 may be configured to execute program code 11 stored within the device 12 or accessible by the device 12, to control the various components and their functions. For example, the program code may be stored in memory 14, or may be downloaded from the server 50 upon request (e.g., as a web application).

The device 12 also includes a display 15, such as a touch-sensitive liquid crystal display (LCD) for providing a graphical user interface for the program code. A graphics circuit (not illustrated) may include one or more processors, decoders, buffers, and program codes configured to receive image signals and render an image on the display 15. One or more input devices 16 are included for user input to control the functionality of the device 12. The input devices 16 may be separate elements, or may be incorporated into the display 15, such as through a touch-screen configuration

One or more communications circuits 17 provide access to a wireless communication network to facilitate communication between the device 12 and the remote server 50. The circuit 17 may include a radio frequency transmitter and receiver for transmitting and receiving signals through an antenna 18. The communications circuit 17 may also include audio processing functionality, and further be configured to send and receive information through various formats, such as but not limited to electronic mail, text messages, files, and streaming audio and video. The communications circuit may also comprise a short-range wireless interface, such as a BLUETOOTH interface, RFID, ZIGBEE, or WIFI interface, a long range cellular phone or satellite communications interface, or a wired interface, such as a serial, USB, micro USB, FIREWIRE Lightning, or Thunderbolt interface. An antenna 18 may be configured for transmitting and receiving wireless signals to and from remote sources (e.g. server 50).

The memory 14 may include one or several types of non-transitory memory, including, for example, read-only memory, flash memory, magnetic or optical storage devices, or the like. In some embodiments, one or more physical memory units may be shared by the various components. Other embodiments may have physically separate memories for one or more of the different components.

The device 12 may further include a GPS component 19 configured to periodically determine a geographic position of the device 12. This may include a GPS receiver that receives signals from a constellation of satellites. This may also include cell identification based on one or nearby cell towers that are part of the mobile communication network 103, Wi-Fi using received signal strength indications and/or wireless fingerprinting, inertial sensors, barometer, short-range wireless computations, Bluetooth beacons, and terrestrial transmitter systems.

Returning to FIG. 1, the user device 12 is able to communicate with the server 50 through various means. This may include communication through a mobile communication network 101 (e.g., a WCDMA, LTE, or WiMAX network). The mobile communication network (MCN) 101 includes a core network 102 and a radio access network (RAN) 103 including one or more base stations 104. The MON 101 may be a conventional cellular network operating according to any communication standards now known or later developed. For example, the MCN 101 may comprise a Wideband Code Division Multiple Access (WCDMA) network, a Long Term Evolution (LTE) network, or WiMAX network. The MCN 101 is further configured to access a packet data network (PDN) 105. The PDN 105 may comprise a public network such as the Internet, or a private network.

As further illustrated in FIG. 1, the user device 12 may also be able to communicate with a wireless access point 106 to access the PDN 105. In one or more embodiments, the communication circuit 17 includes a Wireless Local Area Network (WLAN) interface that operates according to the 802.11 family of standards, which is commonly known as a WiFi interface. The communications circuit 17 of the user device 12 may further include a personal area network (PAN) interface, such as a BLUETOOTH, RFID, and ZIGBEE interface.

The user device 12 may also be connected to a nearby device (not shown) through a wired interface, such as a RS 232, USB or FIREWARE interface. Such a device would be configured to access the PDN 55.

The communication circuit 17 of the user device may also include a Near Field Communication (NFC) interface. Near Field Communication is a short-range wireless connectivity technology that uses magnetic field induction to permit devices to share information with each other over short distances (e.g., on the order of 4 centimeters or less). Communication between two NFC-capable devices is possible when the devices are within close physical proximity to one another, and may be initiated when the devices are actually brought into contact with each other. The distance separating two NFC-capable devices is typically anywhere between about 0 and 4 centimeters, but in some instances can be up to about 20 centimeters.

The user device 12 is configured to communicate through the PDN 55 to the monitoring server 50. The monitoring server 50 may be configured to provide a web interface 51. The system is configured for accessing information through the monitoring server 50 using a browser-based interface or an application program interface (API). The browser-based interface may include a website through which the contents of a database 52 may be accessible. Although the website may be hosted by the server 50, it may also be hosted at another location accessible through the PDN 55.

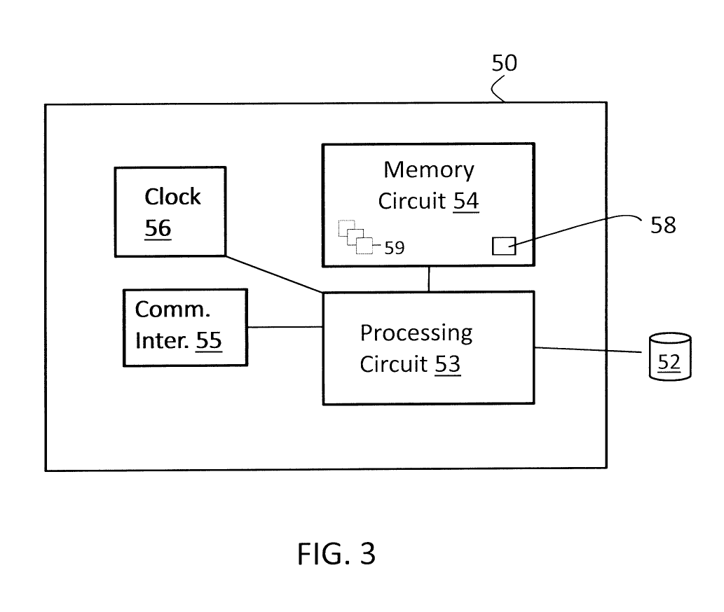

The monitoring server 50 oversees the operation of the system including the user device monitoring and communication. As illustrated in FIG. 3, the monitoring server 50 includes one or more processing circuits (illustrated as processing circuit 53) that may include one or more microprocessors, microcontrollers, Application Specific Integrated Circuits (ASICs), or the like, configured with appropriate software and/or firmware. A computer readable storage medium (shown as memory circuit 54) stores data and computer readable program code that configures the processing circuit 53 to implement the various monitoring techniques. Memory circuit 54 is a non-transitory computer readable medium, and may include various memory devices such as random access memory, read-only memory, and flash memory. A control application 58 may be stored in the memory circuit 54 that, when run by the processing circuit 53, controls the operation of the system. User profiles 59 may be stored in the memory circuit 54. The user profiles 59 include information about each of the users, such as their account information, historic information about previous alerts that they have responded to, etc.

A communication interface 55 connects the server 50 to the PDN 105, and may be configured to communicate with the PDN 105 according to one or more 802.11 standards. The communication interface 55 may support a wired connection (e.g., Ethernet), a wireless connection, or both. The database 52 is stored in a non-transitory computer readable storage medium (e.g., an electronic, magnetic, optical, electromagnetic, or semiconductor system-based storage device). The database 52 may be local or remote relative to the monitoring server 50. A clock 56 may be associated with the processing circuit 53 that measures the various timing requirements for specific events. The clock 56 may be incorporated with the processing circuit 53, or may be a separate component independent from the processing circuit 53. The clock 56 may be configured to measure the specific time during each day, as well as to measure the various time periods (i.e., days, weeks, months, years, etc.).

The monitoring server 50 provides a web interface 51 for users to access their account and obtain various monitoring and communication data. The web interface 51 may support a website through which the contents of the database 52 are accessible. In one or more embodiments the web interface 51 provides browser-based access to the contents of the database 52. The different users may login to the browser-based interface and access the pertinent usage information. The browser-based interface may support well-known browsers such as Internet Explorer and Mozilla Firefox, Safari, Chrome.

Alternatively, the different users may obtain information from the database 52 using one or more Application Programming Interfaces (APIs) through their user device 12. Also, in one or more embodiments the web interface 51 supports access to the database 52 using web services in addition to, or as an alternative to, the browser-based interface.

Initially, each user subscribes to the system. This may include accessing the server 50 and downloading an application that runs on their user device 12. The application may then provide for the user to set up their account by submitting the relevant user information, including but not limited to their name, home address, email address, photograph, and phone number. The server 50 stores this information and associates it with the user. Each user may also be required to establish a personal identification number to access their account or verify entry of various information.

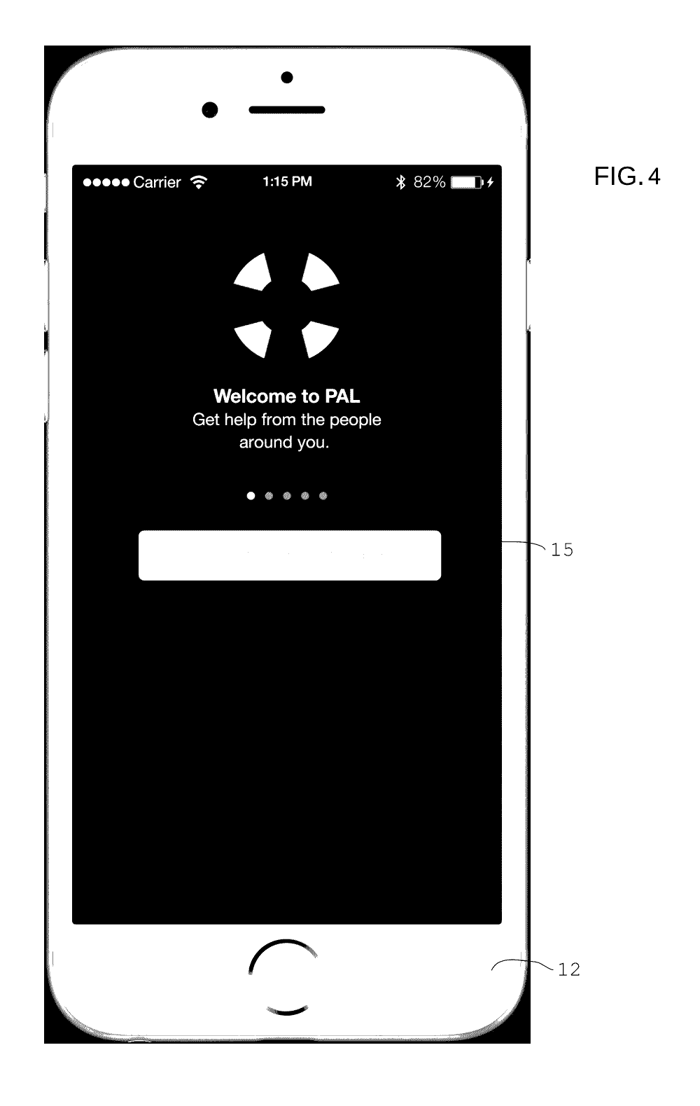

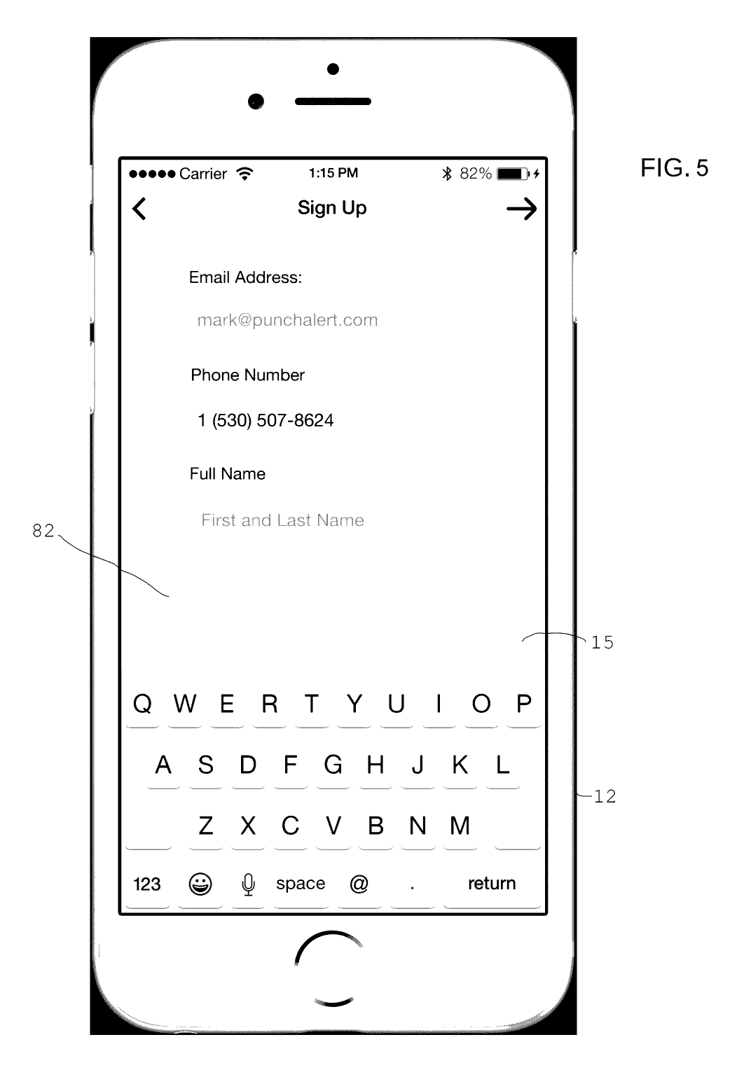

FIGS. 4 and 5 illustrate sign up screens that are displayed on the user device 12 during the initialization process. As illustrated in FIG. 4, the user launches the application on their device 12 and an initialization screen is displayed requesting the user's email address. FIG. 5 includes a subsequent sign-up screen in which the user is requested to input additional information.

The initialization process may be configured to require the user to verify the extent in which the system can be used. This may include verifying that the application is to be used to only help others or request assistance, that the user will receive alerts when another user require assistance, that they should contact the proper authorities as necessary, and that the user is solely responsible for their actions while using the system.

The system allows the user to control various settings which may include a manual radius at which they would like to send and receive alerts to and from other users in the network. Another setting may include the maximum time the system should spend notifying others to achieve a response or escalate further. Another setting may include a ‘do not disturb’ or ‘on duty/off duty’ toggle which would affect if and when alerts are received from other users nearby.

The system may include various groups to which the user may be interested in joining. Example groups include users associated with a local non-profit organization, and users that frequent a nearby restaurant. In one embodiment, a user is automatically enrolled or given an option to enroll in groups that are within a particular geographic distance from their home location (e.g., within 20 miles).

Being a group member results in the user receiving various alerts about the particular organization. Thus, the user will begin receiving alerts from each of these groups upon registering with the system. If necessary, the user may adjust their account setting accordingly to add or remove one or more of these groups. The user may also adjust the geographic distance setting so they are included in more or less groups (e.g., increase the radius from 20 miles to 30 miles).

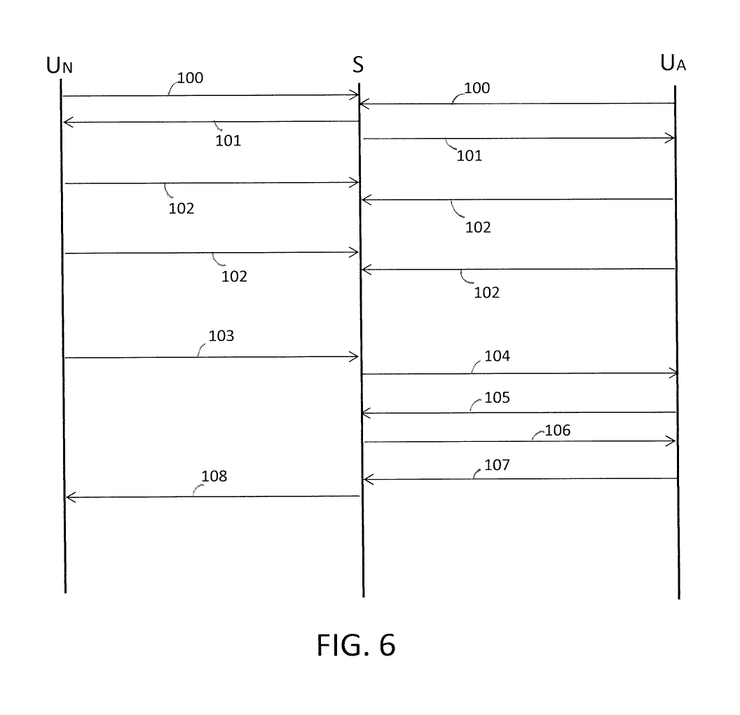

A feature of the system is to provide assistance to a user. The assistance is provided by other users who are alerted of the need and respond that they are available to help. FIG. 6 illustrates a signaling diagram of the communications that occur between a user in need of assistance (Un), assisting user (Ua), and the server 50 (S).

The user devices 12 send an initial signal to the server 50 at the time they are initially powered on. This initial signal 100 may identify the user device 12 and may also include the geographic location that the device 12 reads from the GPS component. Signal 100 also causes the server 50 to add the user to the active network by adding a record to the database 52. Server 50 may send a confirmation 101 to the users to verify that they are active.

After the initial activation, the server 50 monitors the geographic location of each user. This may require that each user device 12 periodically send a signal 102 to notify the server 50 of their geographic location. The signal may be sent at various times, such as on a regular periodic basis (e.g., every 2 minutes, every 5 minutes), or on a more random basis such as when the user device 12 determines that the geographic location has changed beyond a predetermined amount. Alternatively, the server 50 may periodically send a location request to the user device 12 to which a corresponding reply is sent to the server 50.

Upon needing assistance, the requesting user Un controls the device 12 to send an alert signal 103 to the server 50 that they are in need of assistance. The initial alert signal 103 may include the location of the user. Alternatively, the location information may also be sent at a later time, either as an unsolicited signal or in response to a location request from the server 50. The initial request 103 may also include the type of assistance that is needed by the user. Alternatively, this information may be sent later.

The server 50 then determines which active users should be sent the alert. In one embodiment, the server 50 sends the alert to active users within a predetermined radius of the current location of the requesting user. This radius may vary depending upon the type of need. For example, a mechanical issue (e.g., broken-down vehicle) may result in active users within a 5 miles radius receiving the alert. For a medical issue, active users within a 15 mile radius will receive the alert due to the more serious nature of the issue.

In another embodiment, the server 50 determines the number of assisting users that are necessary to respond to the requesting user. This may be based on a predetermined number depending upon the type of need. For example, a mechanical issue may require a single assisting user, while a medical issue may require multiple assisting users. The server 50 further tracks historical data regarding the percentage of active users that are notified and who respond that they are available to help. Finally, the server 50 monitors the location of the active users. Based on this information, the server 50 is able to send the alert to the required number of active users. For example, for a medical issue that requires three responders, the server 50 may calculate based on historical information that there is a 10% of positive results from active users. Therefore, the server 50 calculates that it will need to send the alert to about 30 active users to receive the required number of responders. The server 50 may then determine those 50 active users that are located the closest to the requesting user. Once determined, the server 50 sends 104 to the relevant active users.

Upon receiving the signal 104, the user Ua may signal the server 105 that they are able to help. The server 50 then determines which of these positive responders are qualified to provide assistance. This may include analyzing one or more factors relevant to the ability of the active user to provide the assistance. One factor is the distance that the active user is away from the requesting user, with closer active users receiving a higher factoring grade than those that are located more distant. Another factor is whether the user has any qualifications that are applicable to the specific need. For example, for a broken car a user with car mechanic background would grade higher than other users without mechanic backgrounds, a user with medical training would grade higher for a medical need, and a user with police or law enforcement experience would grade higher for a safety issue. Another factor may be the responding user's history of providing assistance. After each assistance event, the requesting user provides a rating for the assisting user. The rating is stored by the server 50. During the next offer by the assisting user, the server 50 uses the historical rating as another factor in determining whether the user is qualified to respond.

In one embodiment, for example in an emergency, the server 50 may automatically accept the first active users that respond indicating they are able to provide help.

Once the server 50 determines the qualified active users, the server 50 may then reply 106 to the assisting user Ua with more specific information about the alert. This may include the type of assistance that is necessary, information about the requesting user Un, and the location of the requesting user Un. The assisting user Ua may reply 107 that they are able to assist and are moving towards the requesting user Un. Server 50 may signal 108 the requesting user Un of the impending assistance. The server 50 may also include information about the assisting user Ua such that the requesting user Un is able to recognize them upon their arrival.

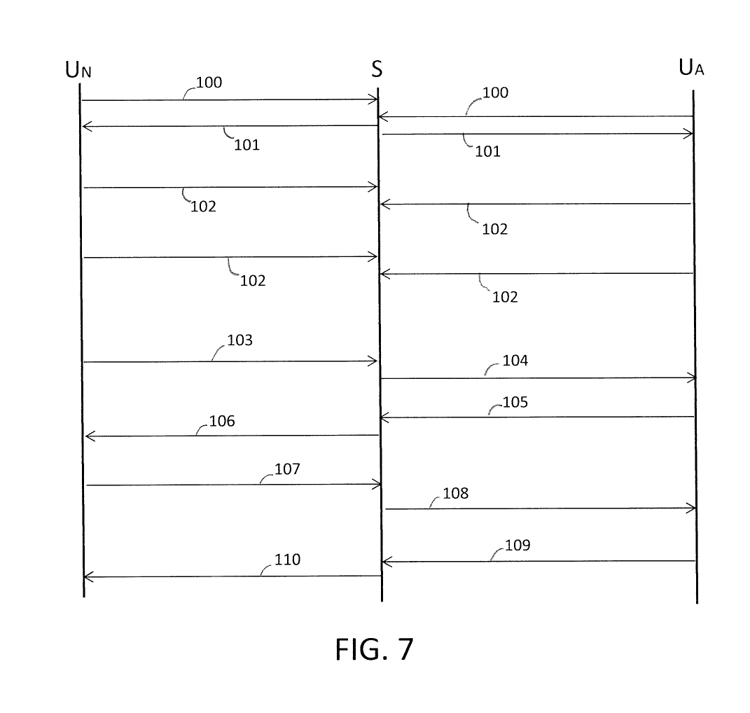

FIG. 7 illustrates another signaling sequence between the requesting user Un, assisting user Ua, and the server 50. The signaling sequence is the same through signal 105 as that described above for FIG. 6. In this embodiment, upon receiving the signal 105 from the assisting user Ua, server 50 signals 106 information about the assisting user Ua to the requesting user Un. This information is provided to ensure that the requesting user Un is comfortable with accepting the offered assistance. The information may include the assisting user's Ua skills, such as car repair or medical training. This information may be particularly applicable when the requesting user Un receives multiple offers for assistance. This information about the responding user may be stored in their user profile and accessed as necessary.

The requesting user Un may then signal 107 the server 50 that they accept the offer to provide assistance. The server 50 then sends 108 the more specific information about the requesting user Un including their geographic location. The assisting user Ua may further signal 109 that they are available and are moving towards the requesting user Un which is further communicated 110 by the server 50.

In some situations, the server 50 may send a single assisting user to the requesting user. Other situations may result with the server 50 sending multiple assisting users. The server 50 may include logic to determine the number of necessary assisting users. For example, a request for medical assistance may result in dispatching multiple assisting users. A request to change a flat tire may result in a single assisting user.

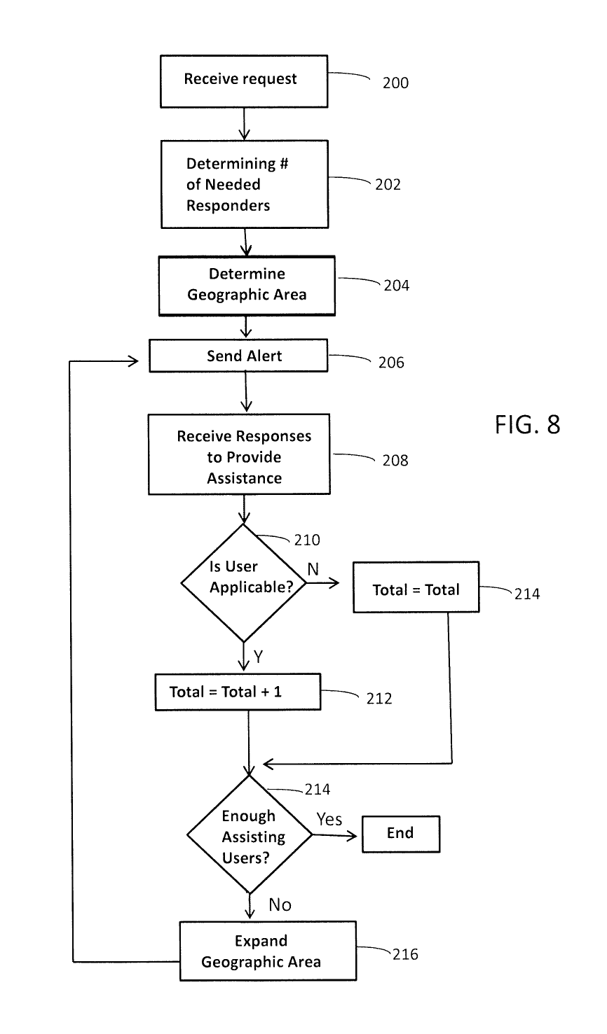

FIG. 8 illustrates one embodiment of the processing performed by the server 50 in responding to a request for assistance. This process begins when the server 50 initially receives the assistance request (block 200). The server 50 calculates the number of assisting users that should be sent (block 202). For example, a medical emergency may require two or more users, while a broken-down vehicle may only require a single user. Further, the required number may vary depending upon the time of day with additional users needed for a nighttime assistance due to safety concerns. Another factor is the location of the requesting user, with additional assistance necessary for an area with a high crime rate.

The server 50 calculates an initial geographic region in which to send the alert (block 204). This may include a default setting, such as a certain radius from the current location of the requesting user. In another embodiment, the server 50 calculates the number of active users within a predetermined distance from the requesting user. Based on an expected percentage of users that will positively respond and the number of users needed for assistance, the server 50 is able to calculate the number of user's that need to be contacted with the alert. The server 50 then sends the alert to the defined active users (block 206).

The server 50 then receives positive replies from users that are able to provide assistance (block 208). The server 10 than determines whether the user is qualified to provide the assistance (block 210). One or more factors may be used by the server 50 to determine whether the responding user is qualified. One factor is whether the user has any qualifications that are applicable to the specific need. For example, for a broken car a user with car mechanic background would meet the requirement. Another example is a user with medical training is applicable to respond to a medical need. Another factor may be the distance the user is away from the location of the requesting user. In one embodiment, an assisting user may need to be within a predetermined radius of the requesting user. Another factor may be the responding user's history of providing assistance. The system may receive input for each event for which the user provided assistance in the past. In one embodiment, this may include a numerical rating. The server 50 then determines the responding user's average rating in calculating whether the user is applicable.

If the user is calculated to be acceptable to provide assistance, the server 50 increments a counter of assisting users (block 212). If the user is not acceptable, the counter remains the same (block 214). If the number of assisting users is satisfied, the server 50 ends obtaining additional users. If the number is not adequate (block 214), the server 50 expands the geographic region in which to try to find other responding users (block 216). This may be increasing the radius from the requesting user from which potential users are sent the alert. In another embodiment, the server 50 calculates the number of active users in the system and sends the alert to a predetermined number of the closest users.

The server 50 may also factor in the time since the alert was sent to a first group of users in determining whether to expand the alert area. If a predetermined amount of time has elapsed since the alert was sent and the required number of responders has not been met, the server 50 may expand the alert area. For example, if the alert has been sent out and within 10 minutes there still have not been enough qualified responders, the alert area will be increased and additional users will be sent the alert. The amount of time before the search area is increase may vary depending upon the type of need. For example, for a medical emergency, the time may be less than for a mechanical issue. Further, other factors may lessen the amount of elapsed time before the alert area is expanded, such as the time of day (e.g., a person stranded at night may cause the search to increase faster than if they were stranded during the day), or whether an area has a high crime rate may increase the expanded search area faster.

The system may also provide for an escalation on the need for assistance. The system provides for each user to be able to contact other users in the event of a need. For example, each user is able to contact others in their groups simply by sending one group message.

The system also provides for a re-report function. This allows users to resend an alert that they have received. The re-report function may be enabled so people can extend the radius of the community alert in a viral way outward from the emergency itself. This inside-out method of alerting is counter to the traditional method of mass alerting from one central location out to the masses. It has the benefit of spreading potentially much quicker and not relying on a single node to create the mass alert and with access and knowledge required to distribute to the right people.

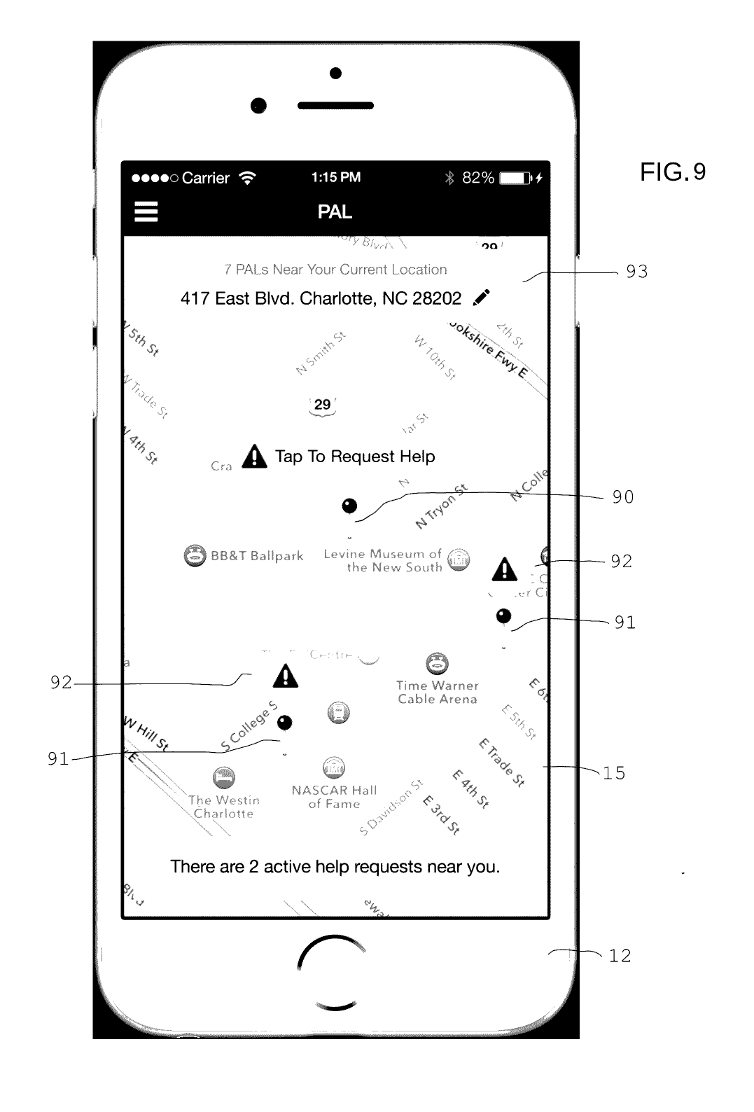

In use, the system provides for a variety of different features when the application is running on their user equipment 12. FIG. 9 includes one embodiment of the application running on a user device 12 with features being visible on the display screen 15. One feature includes displaying the current location of the user on a map. The maps may be stored in the database 52 and accessed by the server 50 as necessary. The server 50 may also access the maps through one or more different sources. The graphics on the display 15 may include a pin 90 or other visual indicia indicating the current location of the user. The graphics may also include the current location in a banner 93. The user is able to manipulate the map to expand or decrease the view size as necessary. In addition, the graphics may also display the number of other active users within the same general geographic location.

The graphics also identifying locations 91 of requesting users that are within proximity to the user's current location. The graphics may include inputs 92 to allow the user to see more specific information about the requesting user. The size of the geographic area that is displayed may be set, or it may be dynamic. The user may be able to adjust the size of the search area to further be informed of the other users within a particular distance from their current location.

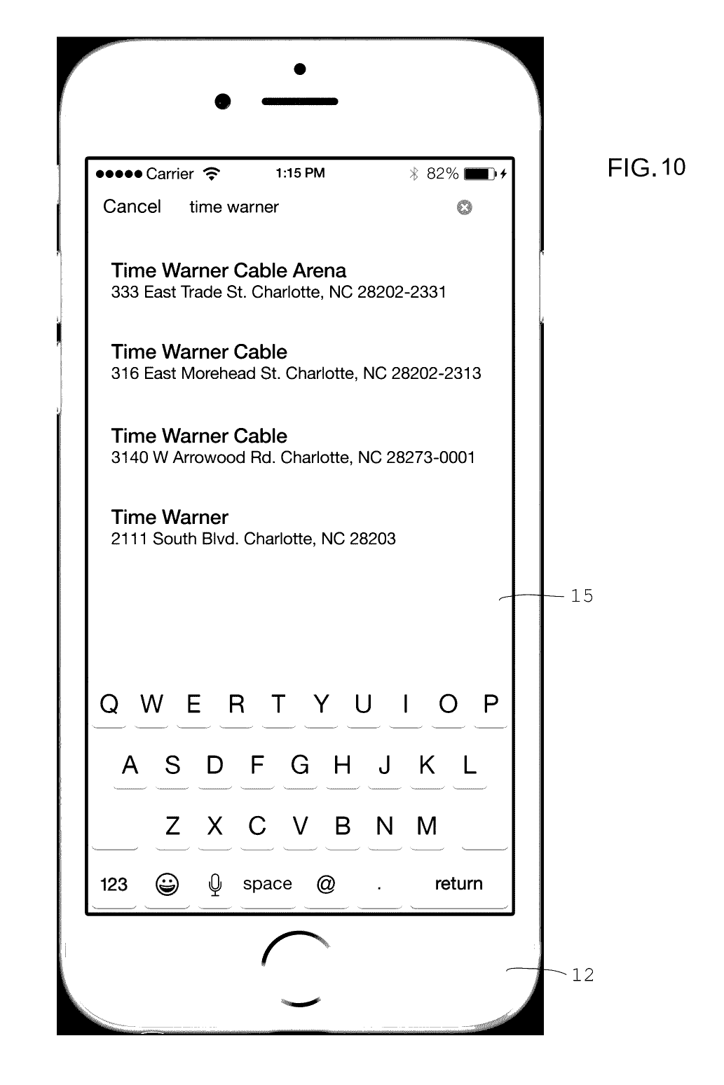

When a user is in need of assistance, the server 50 may determine their geographic location in a number of different manners. In one embodiment, the server 50 receives updates regarding the user's location through communications from the user device. Upon receiving an assistance alert, the server 50 uses the location as the last reported location. The system is further configured for the user to enter a different geographic location than their actual current location. In one embodiment, the user touches the map displayed on the display screen 15 at the geographic location where assistance is needed. This may require the user to maintain the contact at this position on the display 15 for an extended period (e.g., 5 seconds, 10 seconds). This causes the user device 12 to signal the server 50 of the need for assistance at this location. This may be helpful when the user is aware of a need at a location where they are not physically located. For example, the user may see a report on the news that help is needed at a particular location. In another embodiment as illustrated in FIG. 10, the user may enter an address where assistance is needed.

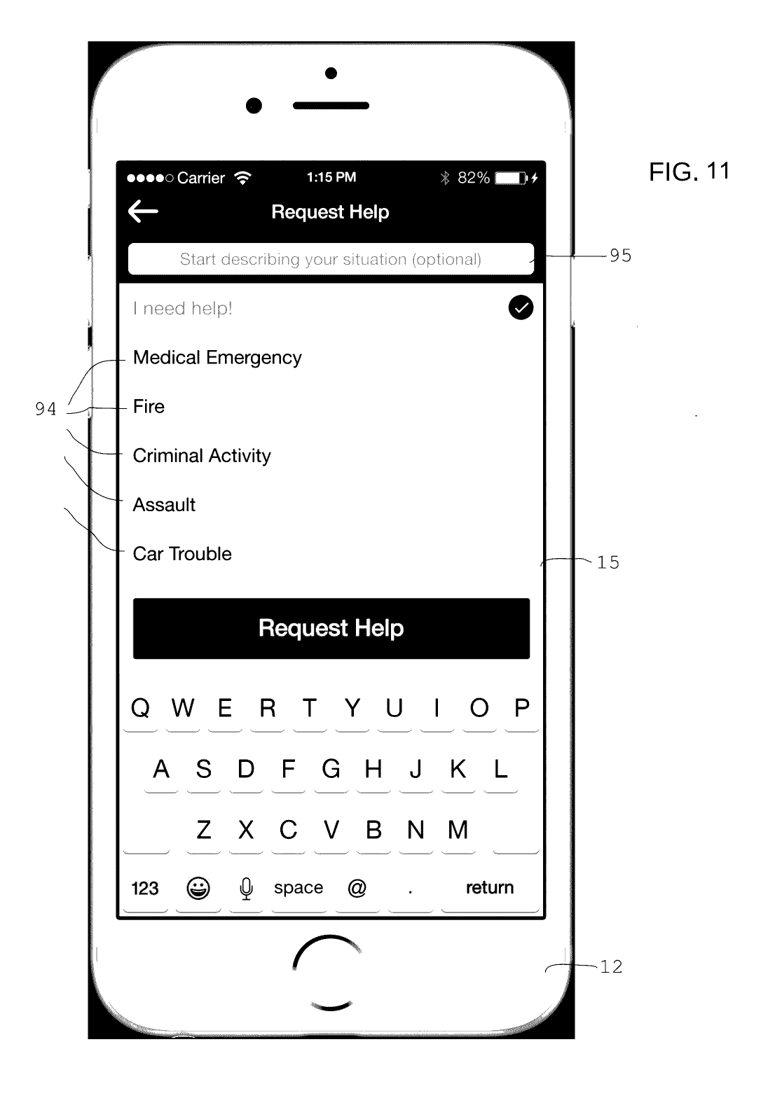

The system also provides for the user to enter the type of assistance that is needed. As illustrated in FIG. 11, the application may be configured to display preset options 94 that the user can select. The application may also provide an input location 95 for the user to input the type of needed assistance.

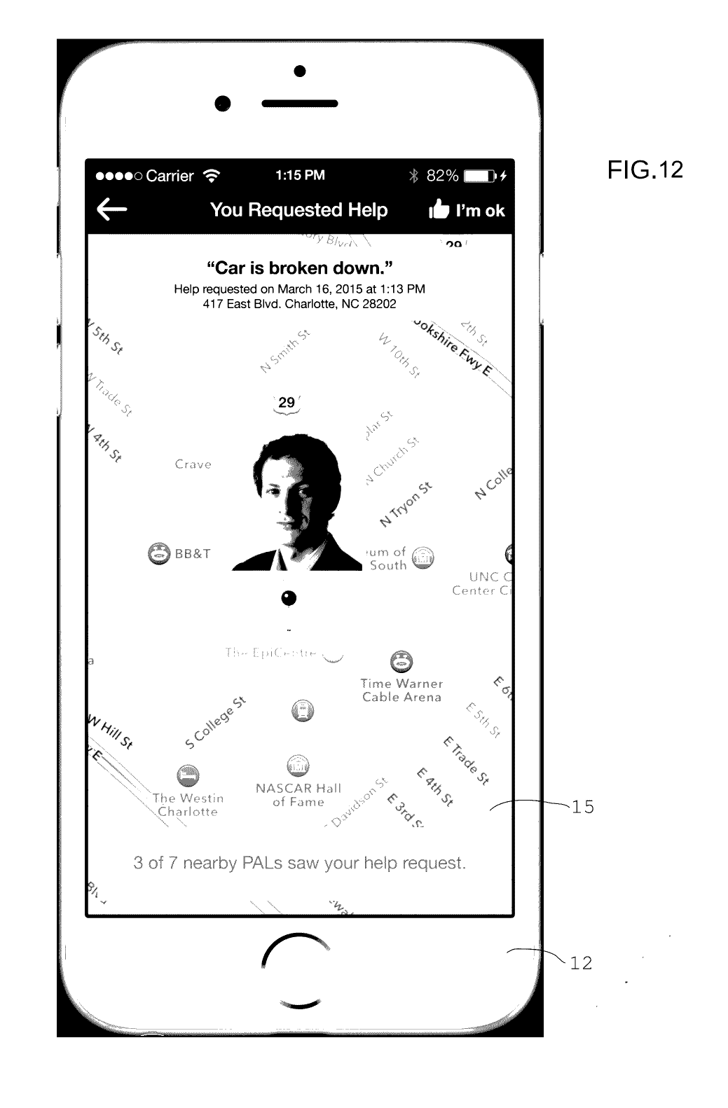

After the assistance request is sent to the server 50, the assistance request if sent to the requesting user. As illustrated in FIG. 12, this may include the number of active users that are within the geographic area and that have been alerted, the number of active users that read the alert, and the number of users indicating they will come to help. The name, profile photo, and real-time locations of the active users that have responded and that are on their way may also be displayed. The user device may also be configured to provide quick and straight-forward access to call or text 911 emergency personnel or otherwise alert responder in the event that their assistance is necessary.

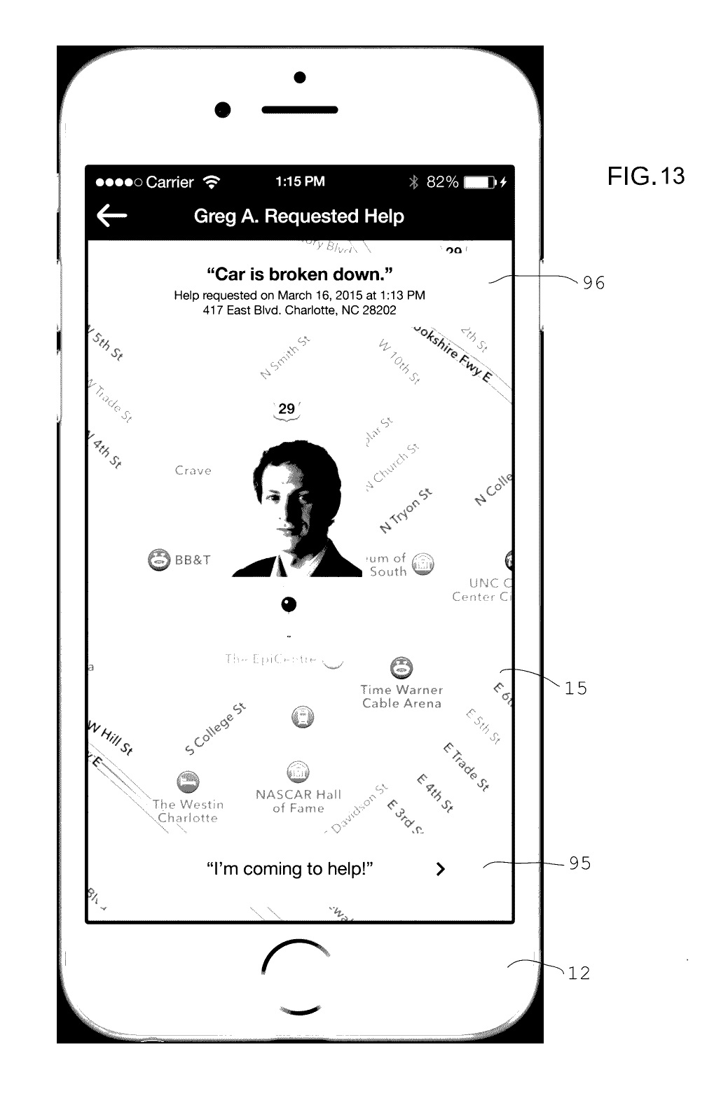

Active users who are candidates to provide assistance in the geographic area of the requesting user receive an alert. The alert may include one or more of the type of needed assistance, and the location of the requesting user, and a map of the requesting user's location. As illustrated in FIG. 13, the alert may also include an input location 95 for the candidate to indicate whether or not they are able to help.

The initial request may include the specific information about the alert, Alternatively, the initial request may include a limited amount of information. Upon receiving the reply and determining that the candidate is acceptable, additional information may be provided by the server 50 to the assisting user, such as an exact location of the requesting user and a photo of the requesting user.

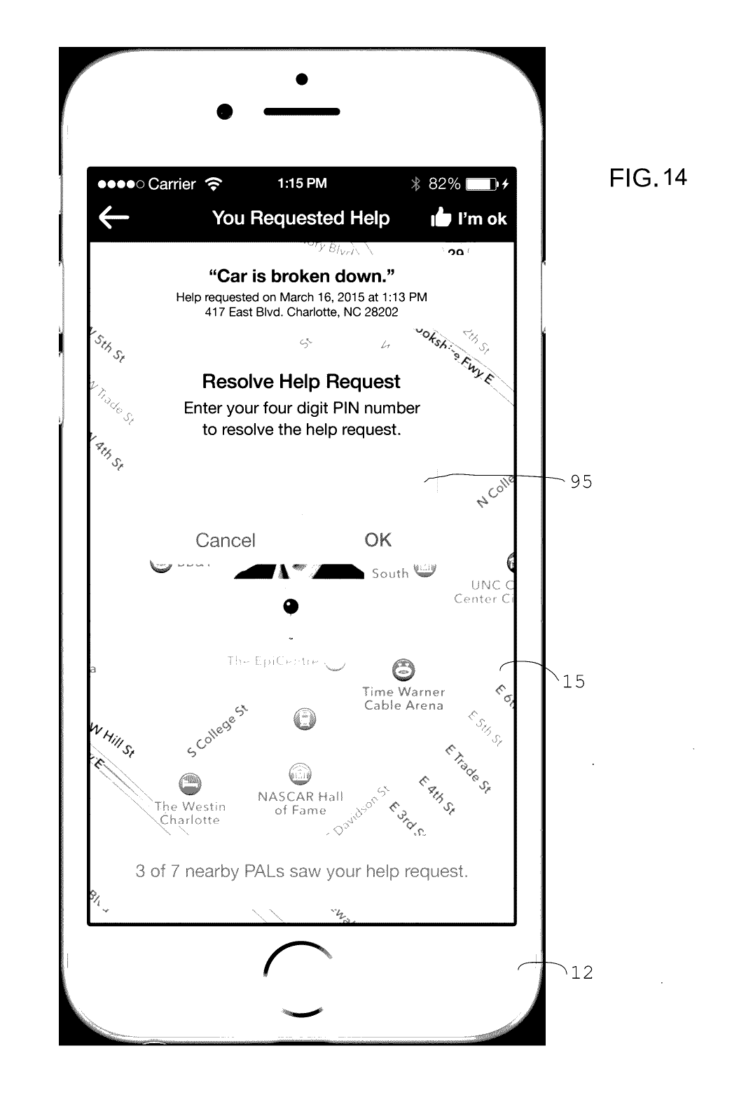

The system further provides for the requesting user to signal how the issue was resolved. FIG. 14 includes a display with an input screen 95 for the requesting user to enter that they are safe and the issue is resolved. This may further require that the user input their identification number to validate that the input is coming from the actual user.

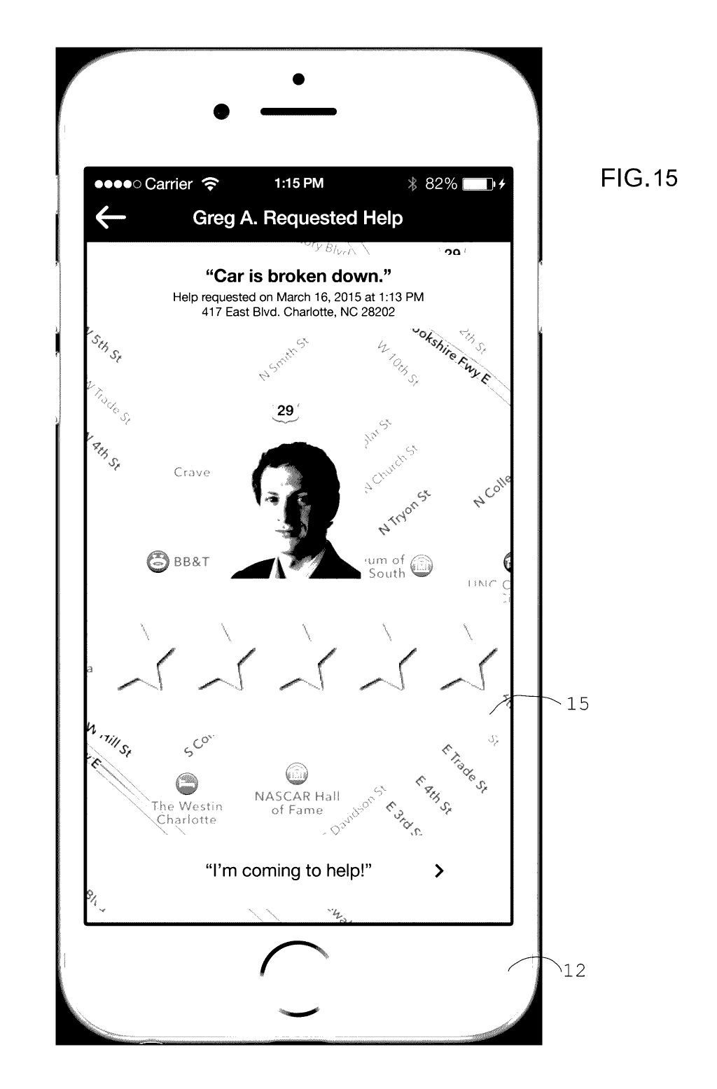

The system also provides for the needy user to rate their experience. As illustrated in FIG. 15, this may include reporting improper use of the system, reporting malicious intent of a user, rating the usefulness or helpfulness of the system such as by using a 1-5 rating scale.

In one embodiment, the system may provide for peer-to-peer technology which may be embedded in the operating systems such as IOS, Android, or other operating systems. This would allow the user devices 12 to speak to one another directly when in near proximity could reduce or eliminate reliance on a data connection (such as cell or WiFi) to the Internet. There are several benefits to this technology:

In a disaster scenario, if cell coverage is down and WiFi is unavailable, this may be critical to enable communication;

This may be used to ensure the location accuracy that users notified are in very close proximity;

This may allow user devices 12 to conserve on battery life that would otherwise be allocated to more draining location-related (GPS, in particular) activities;

There may be financial compensation in the form of pre-set rates or tipping as a component of the process;

There may be a premium version of the system for a subscription fee that offers increased security or other features;

Private organizations may be offered an option to deliver their services or communicate with users; and

Public organizations may be offered an option to deliver their services or communicate with users.

The methods and systems may be implemented on any computer communicating over any network. For example the user devices 12 may include desktop computers, tablets, handheld devices, laptops and mobile devices. The mobile devices may comprise many different types of mobile devices such as cell phones, smart phones, PDAs, portable computers, tablets, and any other type of mobile device operable to transmit and receive electronic messages.

The computer network(s) may include the internet and wireless networks such as a mobile phone network. Any reference to a “computer” is understood to include one or more computers operable to communicate with each other. Computers and devices comprise any type of computer capable of storing computer executable code and executing the computer executable code on a microprocessor, and communicating with the communication network(s). For example computer may be a web server.

References to electronic identifiers may be used which include, but are not limited to, email addresses, mobile phone numbers, user IDs for instant messaging services, user IDs for social networking application or mobile applications, user IDs and URLs for blogs and micro-blogs, URls, bank account or financial institution numbers, routing numbers, credit and debit cards, any computer readable code, and other electronic identifiers to identify accounts, users, companies, and the like.

The systems and methods may be implemented on an Intel or Intel compatible based computer running a version of the Linux operating system or running a version of Microsoft Windows, Apple OS, Android, and other operating systems. Computing devices based on non-Intel processors, such as ARM devices may be used. Various functions of any server, mobile device or, generally, computer may be implemented in hardware and/or in software, including in one or more signal processing and/or application specific integrated circuits.

The computers and, equivalently, mobile devices may include any and all components of a computer such as storage like memory and magnetic storage, interfaces like network interfaces, and microprocessors. For example, a computer comprises some of all of the following: a processor in communication with a memory interface (which may be included as part of the processor package) and in communication with a peripheral interface (which may also be included as part of the processor package); the memory interface is in communication via one or more buses with a memory (which may be included, in whole or in part, as part of the processor package; the peripheral interface is in communication via one or more buses with an input/output (I/O) subsystem; the I/O subsystem may include, for example, a graphic processor or subsystem in communication with a display such as an LCD display, a touch screen controller in communication with a touch sensitive flat screen display (for example, having one or more display components such as LEDs and LCDs including sub-types of LCDS such as IPS, AMOLED, S-IPS, FFS, and any other type of LCD; the I/O subsystem may include other controllers for other I/O devices such as a keyboard; the peripheral interface may be in communication with either directly or by way of the I/O subsystem with a storage controller in communication with a storage device such a hard drive, non-volatile memory, magnetic storage, optical storage, magneto-optical storage, and any other storage device capable of storing data; the peripheral interface may also be in communication via one or more buses with one or more of a location processor such as a GPS and/or radio triangulation system, a magnetometer, a motion sensor, a light sensor, a proximity sensor, a camera system, wireless communication subsystem(s), and audio subsystems.

A non-transitory computer readable medium, such as the memory and/or the storage device(s) includes/stores computer executable code which when executed by the processor of the computer causes computer to perform a series of steps, processes, or functions. The computer executable code may include, but is not limited to, operating system instructions, communication instruction, GUI (graphical user interface) instructions, sensor processing instructions, phone instructions, electronic messaging instructions, web browsing instructions, media processing instructions, GPS or navigation instructions, camera instructions, magnetometer instructions, calibration instructions, and social networking instructions.

An application programming interface (API) permits the systems and methods to operate with other software platforms such as Salesforce CRM, Google Apps, Facebook, Twitter, social networking sites, desktop and server software, web applications, mobile applications, and the like. For example, an interactive messaging system could interface with CRM software and GOOGLE calendar.

A computer program product may include a non-transitory computer readable medium comprising computer readable code which when executed on the computer causes the computer to perform the methods described herein. Databases may comprise any conventional database such as an Oracle database or an SQL database. Multiple databases may be physically separate, logically separate, or combinations thereof.

The features described can be implemented in any digital electronic circuitry, with a combination of digital and analog electronic circuitry, in computer hardware, firmware, software, or in combinations thereof. The features can be implemented in a computer program product tangibly embodied in an information carrier (such as a hard drive, solid state drive, flash memory, RAM, ROM, and the like), e.g., in a machine-readable storage device or in a propagated signal, for execution by a programmable processor; and method steps can be performed by a programmable processor executing a program of instructions to perform functions and methods of the described implementations by operating on input data and generating output(s).

The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any type of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. Some elements of a computer are a processor for executing instructions and one or more memories for storing instructions and data. Generally, a computer will also include, or communicate with one or more mass storage devices for storing data files. Exemplary devices include magnetic disks such as internal hard disks and removable disks, magneto-optical disks, and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) for displaying information to the user and a keyboard and a pointing device such as a mouse or a trackball by which the user can provide input to the computer. The display may be touch sensitive so the user can provide input by touching the screen.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, wired and wireless packetized networks, and the computers and networks forming the Internet.

The foregoing detailed description has discussed only a few of the many forms that this invention can take. It is intended that the foregoing detailed description be understood as an illustration of selected forms that the invention can take and not as a definition of the invention. It is only the claims, including all equivalents that are intended to define the scope of this invention.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A method of monitoring users comprising:
receiving a request over a wireless communication network for assistance from a requesting user;
based on the request, determining a number of active users necessary to provide the assistance to the requesting user;
determining a size of a geographic area that extends around the requesting user based on one or more factors regarding the requesting user and the assistance requested by the requesting user;
sending an alert to the active users within the geographic area, the alert comprising the assistance requested by the requesting user;
receiving responses from the active users indicating a desire to respond to the requesting user;
for each of the responses, determining that the active user is qualified to respond; and
notifying each of the active users that is qualified to respond to provide the assistance to the requesting user, the confirmation comprising at least a geographic location of the requesting user.

2. The method of claim 1, wherein determining which of the one or more active users are applicable to respond to the requesting user comprises calculating a distance from each of the active users to the geographic location of the requesting user.

3. The method of claim 1, wherein determining which of the one or more active users are applicable to respond to the requesting user comprises determining whether qualifications of the active user that are stored at a server are applicable to the assistance requested by the requesting user.

4. The method of claim 1, wherein determining which of the one or more active users are applicable to respond to the requesting user comprises determining a history of the active user in responding to previous assistance requests.

5. The method of claim 1, further comprising centering the geographic area around a geographic location of the requesting user.

6. The method of claim 1, further comprising:
determining that additional active users are needed by the requesting user;
expanding the geographic area that extends around the user to an enlarged area based on the number of additional active users that are needed; and
sending the alert to the active users within the enlarged area, the alert comprising the assistance requested by the requesting user.

7. A method of monitoring users comprising:
receiving a request over a wireless communication network for assistance from a requesting user;
based on the request, determining a total number of active users necessary to provide the assistance to the requesting user;
sending a first alert to the active users that are located within a first radius of the requesting user, the alert comprising the assistance requested by the requesting user;
determining a first group of the active users that responded to the first alert and who are qualified to respond;
determining that the first group is less than the total number of active users necessary to provide the assistance to the requesting user;
sending a second alert to the active users that are located within a larger second radius of the requesting user, the second alert comprising the assistance requested by the requesting user;
determining that a second group of the active users that responded to the second alert are qualified to respond;
determining that a sum of the first and second groups is equal to or greater than the total number of active users necessary to provide the assistance to the requesting user; and
sending an order to each of the active users of the first and second groups to provide the assistance to the requesting user.

8. The method of claim 7, further comprising including a geographic location of the requesting user in the order.

9. A method of monitoring users comprising:
receiving a request over a wireless communication network for assistance from a requesting user, the request comprising a specific need of the requesting user;
based on the need of the user, determining a required number of active users necessary to provide the assistance to the requesting user;
based on an expected acceptance rate from previous assistance requests, determining an expected number of the active users that must be notified to get the required number of active users;
sending an alert to the expected number of active users that are each within a predetermined radius of a current location of the requesting user, the alert comprising the assistance requested by the requesting user but not including the current location of the requesting user;
receiving acceptances from a group of the active users indicating that they are able to respond to the requesting user;
determining which of the active users in the first group are qualified to provide the assistance to the requesting user and determining which of the active users are not qualified to provide the assistance to the requesting user; and
sending an order to the qualified active users to provide the assistance to the requesting user and including the current location of the requesting user.

10. The method of claim 9, wherein determining which of the active users in the first group are qualified to provide the assistance to the requesting user comprises determining the active users that are geographically closest to the current location of the requesting user.

11. The method of claim 9, further comprising resending the alert to a larger group of the active users that are located geographically farther away from the current location of the requesting user in response to failing to receive a predetermined number of acceptances after initially sending the alert to the expected number of the active users.
